(19) United States
(12) Patent Application Publication
(10) Pub. No.: US 2015/0331218 A1
(43) Pub. Date: Nov. 19, 2015

(54) LENS AND METHOD OF PRODUCING THE SAME

(71) Applicant: CALIN TECHNOLOGY CO., LTD., Taichung City (TW)

(72) Inventors: Chun-Ming CHEN, Taichung City (TW); Kuo-Chin HUNG, Taichung City (TW)

(73) Assignee: CALIN TECHNOLOGY CO., LTD., Taichung City (TW)

(21) Appl. No.: 14/279,000

(22) Filed: May 15, 2014

(51) Int. Cl. G02B 7/02; G02B 3/00; C03B 11/00; G02B 1/00

(52) U.S. Cl. CPC G02B 7/02; G02B 1/00; G02B 3/00; C03B 11/00

(57) ABSTRACT

A lens made of glass, includes a first surface, a second surface, and a flange. The first surface has a locating portion and a first reference portion abutting against a first positioning object to fix a relative position between the first surface and the first positioning object in an axial direction and a radial direction thereof. The second surface has a second reference portion abutting against a second positioning object to fix a relative position between the second surface and the second positioning object in an axial direction thereof. The flange is formed on an outer periphery around the first surface and the second surface.

### BACKGROUND OF THE INVENTION

1. Field of the Invention The present invention relates generally to optics, and more particularly to a lens and a method of producing the lens.

2. Description of the Related Art

With the advances in optical technology, optical devices such as cameras, camcorders, and projectors are getting more and more popular. Optical performance of such optical devices is highly dependent on their optical lenses. In this view, optical lens can be considered the most important component of any optical device.

An optical lens typically includes a lens barrel and a series of lenses installed inside the barrel. If any of the lenses is installed inaccurately to affect the relative positions between the lenses, the optical performance of the optical lens may not be as expected. In other words, minimizing the errors at installing the lenses is critical to manufacture optical lenses of designed optical performance.

The assembling process of a lens usually fixes the position of the lenses by abutting their outer peripheries against the inner structure of the lens barrel. Therefore, the outer periphery of each lens is typically burnished or cut to fit the inner shape of the lens barrel. Such burnishing or cutting process is time-consuming and cumbersome. Furthermore, in order to assemble conveniently, the inner diameter of the lens barrel is usually larger than the diameter of the lenses, which tends to generate errors, and the optical performance may not be ensured.

### SUMMARY OF THE INVENTION

Therefore, the primary objective of the present invention is to provide a lens and a method of producing the lens, which can reliably and assuredly fix relative positions between a series of the lenses while assembling an optical lens.

According to the objective of the present invention, the present invention provides a lens made of glass, which abuts against a first positioning object and a second positioning object, and includes a first surface, a second surface, and a flange. The first surface has a first lens portion at a center, a locating portion, and a first reference portion, wherein the locating portion and the first reference portion surround the first lens portion, and abut against the first positioning object to fix a relative position between the first surface and the first positioning object in both an axial direction and a radial direction thereof. The second surface is opposite to the first surface, wherein the second surface has a second lens portion at a center, and a second reference portion surrounds the second lens portion and abuts against the second positioning object to fix a relative position between the second surface and the second positioning object in an axial direction thereof. The flange is on an outer periphery around the first surface and the second surface, wherein the locating portion and the first reference portion are between the first lens portion and the flange, and the second reference portion is between the second lens portion and the flange.

The present invention further provides a method of producing the lens, which includes the following steps: A. Prepare a first mold and a second mold, wherein the first mold has a first cavity, and the second mold has a second cavity, which is precisely aligned with the first cavity; B. Place an unsolidified glass material onto the first mold, wherein the glass material is between the first cavity and the second cavity; C. Move one of or both the first mold and the second mold to make them closer to each other without being mutually contacted, wherein the glass material is pressed by a wall of the second cavity, and therefore a part of the glass material flows out of a portion between the first cavity and the second cavity, and the portion is inside a spacing between the first mold and the second mold; D. Solidify the glass material, wherein the first surface is formed at where the glass material contacts a wall of the first cavity, the second surface is formed at where the glass material contacts the wall of the second cavity, and the flange is formed of the part of the glass material which is in the spacing between the first mold and the second mold; E. Move away one of or both the first mold and the second mold to retrieve the lens.

Whereby, with the structure of the locating portion, the first reference portion, and the second reference portion, the relative position between the lens and other positioning objects (such as another lens or a gasket) can be reliably and assuredly fixed without being affected by the lens barrel during the assembling process.

### BRIEF DESCRIPTION OF THE DRAWINGS

FIG. 1 is a perspective view of the lens of a preferred embodiment of the present invention;

FIG. 2 is a sectional view of the lens of the preferred embodiment of the present invention; and

FIG. 3 and FIG. 4 are schematic diagrams showing the process of manufacturing the lens of the preferred embodiment of the present invention.

### DETAILED DESCRIPTION OF THE INVENTION

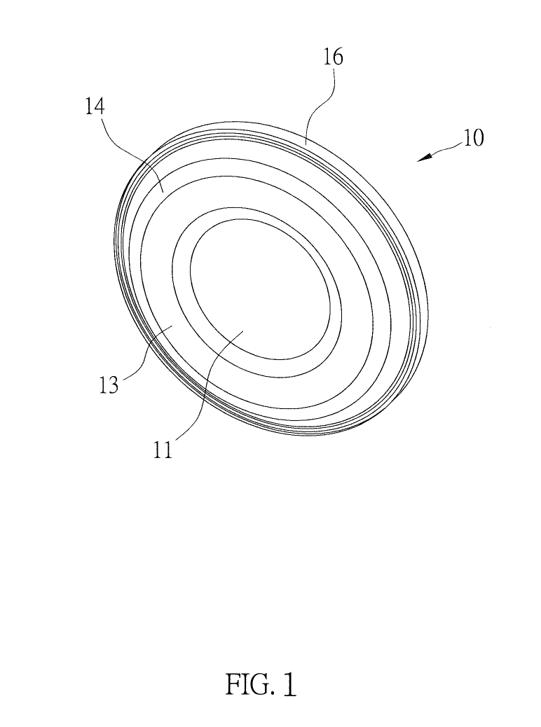

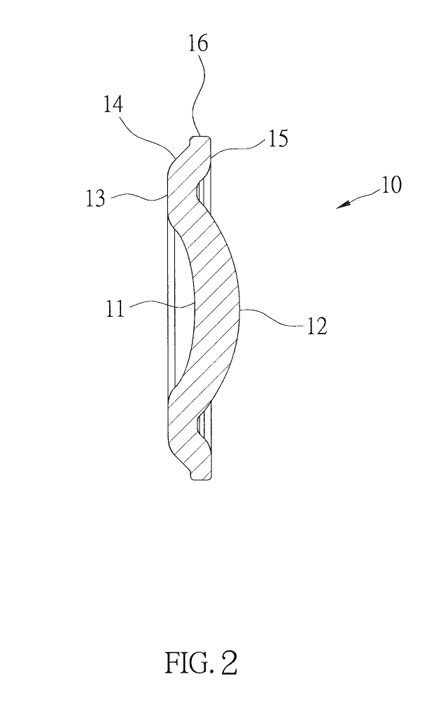

As shown in FIG. 1 and FIG. 2, a lens 10 of a preferred embodiment of the present invention is made of glass, and has a first surface, a second surface opposite to the first surface, and an outer periphery around the first surface and the second surface. The main difference between the present invention and the prior arts is that the first surface has a first lens portion 11 at a center, a first reference portion 13, and a locating portion 14, wherein the first reference portion 13 and the locating portion 14 surround the first lens portion 11, and the locating portion 14 has an inclined plane. The first reference portion 13 is closer to the first lens portion 11 than the locating portion 14. In other words, the first reference portion 13 and the locating portion 14 are arranged sequentially in a direction from the first lens portion 11 to the outer periphery.

The design purpose of the locating portion 14 and the first reference portion 13 is to directly abut against a first positioning object such as a lens (not shown) during an assembling process to manufacture an optical lens. Since the first reference portion 13 directly abuts against the first positioning object, a relative position between the first surface and the first positioning object can be fixed in an axial direction of the first surface. In addition, the relative position can be also fixed in a radial direction of the first surface because that the locating portion 14 directly abuts against the first positioning object. Besides, the first reference portion 13 and the locating portion 14 have an included angle in between, wherein the included angle is an obtuse angle. The fixation effect between the locating portion 14, the first reference portion 13, and the first positioning object can be ensured with the obtuse angle.

In addition, the second surface also has a second lens portion 12 at a center, and a second reference portion 15 surrounds the second lens portion 12. The second reference portion 15 is used to abut against a second positioning object such as another lens or a gasket (not shown), and therefore a relative position between the second surface and the second positioning object can be fixed in an axial direction of the second lens surface. It is worth mentioning that surfaces of the second reference portion 15 and the first reference portion 13 are parallel to each other. After the first positioning object and the second positioning object being assembled with the lens 10, the errors between axial directions of the first positioning object and the second positioning object can be effectively eliminated with such design.

In this way, with the structure of the locating portion 14, the first reference portion 13, and the second reference portion 15, the relative position between the lens 10 and other positioning objects (such as another lens or a gasket) can be reliably and assuredly fixed in the axial directions and the radial direction, without being affected by a lens barrel during the assembling process. As a result, an optical performance of the optical lens which contains the lens 10 can be ensured to be as good as designed.

A method of producing the lens 10 is as followings:

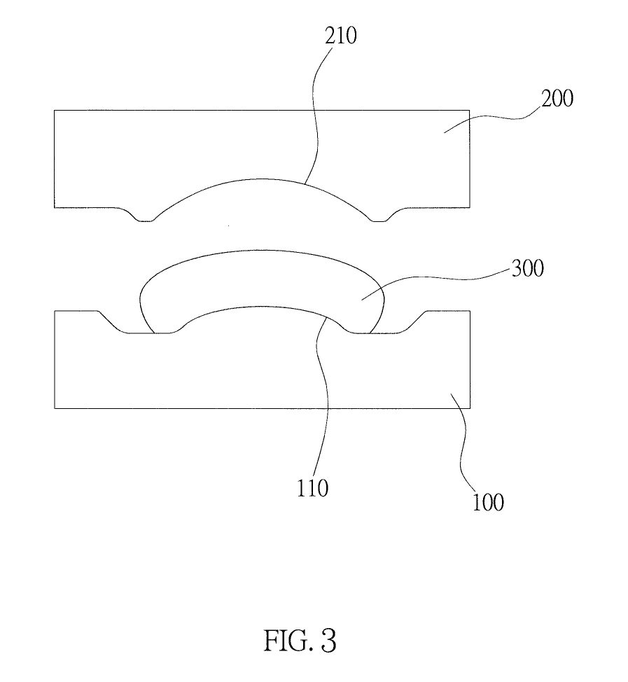

As shown in FIG. 3, prepare a first mold 100 and a second mold 200 first, wherein the first mold 100 has a first cavity 110, and the second mold 200 has a second cavity 210, which is precisely aligned with the first cavity 110.

After that, place an unsolidified glass material 300 onto the first mold 100 to let the glass material 300 between the first cavity 110 and the second cavity 210. And then move the second mold 200 to make the first mold 100 and the second mold 200 closer to each other. The first mold 100 and the second mold 200 always have a spacing D in between, which means they don't contact each other. In practice, of course, it can be the first mold 100 to be moved; or even the first mold 100 and the second mold 200 are moved altogether to achieve the same purpose.

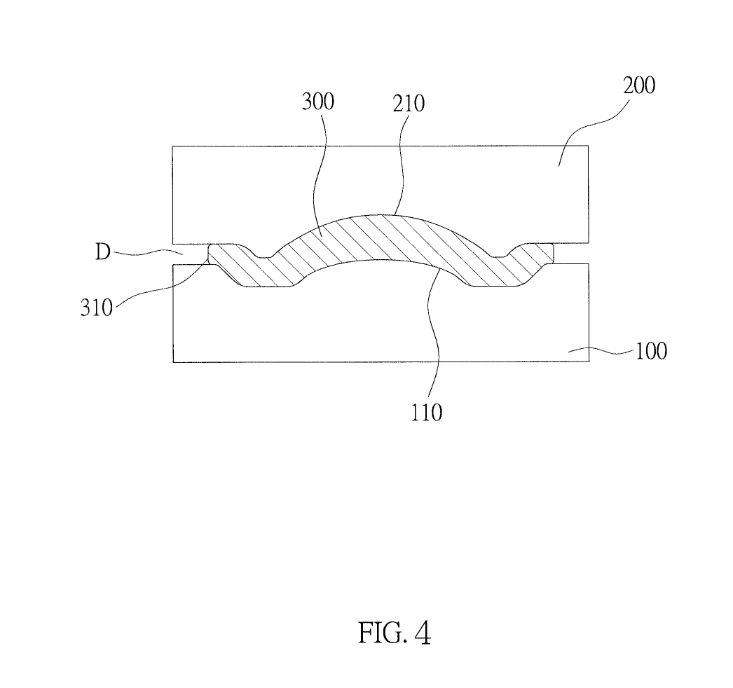

As shown in FIG. 4, the glass material 300 is then pressed by a wall of the second cavity 210, and therefore the first surface is formed at where the glass material 300 contacts a wall of the first cavity 110, while the second surface is formed at where the glass material 300 contacts the wall of the second cavity 210. Furthermore, a part of the glass material 300 flows out of a portion 310 between the first cavity 110 and the second cavity 210, wherein the portion 310 is inside the spacing D between the first mold 100 and the second mold 200.

Finally, solidify the glass material 300, and move the second mold 200 away from the first mold 100 to form the first surface at where the glass material 300 contacts the wall of the first cavity 110, and the second surface at where the glass material 300 contacts the wall of the second cavity 210. The part of the glass material 300 which is originally in the portion 310 inside the spacing D forms a flange 16 on the outer periphery of the lens 10. The lens 10 shown in FIG. 1 and FIG. 2 is then obtained. In more details, the first reference portion 13 and the locating portion 14 are between the first lens portion 11 and the flange 16, and the second reference portion 15 is between the second lens portion 12 and the flange 16.

Therefore, the lens 10 does not directly contact the lens barrel (not shown) during the assembling process to manufacture the optical lens. Instead, the relative position between the lens 10 and other positioning objects (such as another lens or a gasket) is fixed with the structure of the first reference portion 13, the locating portion 14, and the second reference portion 15. As a result, an optical center of the lens 10 is not affected by the structure of the flange 16, and is not biased.

In other words, a shape of the flange 16 is not necessary to fit an inner structure of the lens barrel. Therefore, the flange 16 is no need to be burnished or cut after the lens 10 is formed, which greatly increases the producing efficiency of the lens 10.

In summary, the lens 10 and its producing method provided in the present invention not only ensure the position of the lens during the assembling process, but also enhance the producing efficiency of the lens 10 to save manpower and cost.

It must be pointed out that the embodiments described above are only some preferred embodiments of the present invention. All equivalent structures which employ the concepts disclosed in this specification and the appended claims should fall within the scope of the present invention.

What is claimed is:

1. A lens made of glass, which abuts against a first positioning object and a second positioning object, comprising:
a first surface having a first lens portion at a center, a locating portion, and a first reference portion, wherein the locating portion and the first reference portion surround the first lens portion, and abut against the first positioning object to fix a relative position between the first surface and the first positioning object in both an axial direction and a radial direction thereof;
a second surface opposite to the first surface, wherein the second surface has a second lens portion at a center, and an second reference portion surrounds the second lens portion and abuts against the second positioning object to fix a relative position between the second surface and the second positioning object in an axial direction thereof; and
a flange, which is on an outer periphery around the first surface and the second surface, wherein the locating portion and the first reference portion are between the first lens portion and the flange, and the second reference portion is between the second lens portion and the flange.

2. The lens as defined in claim 1, wherein surfaces of the first reference portion and the second reference portion are substantially parallel to each other.

3. The lens as defined in claim 1, wherein the first reference portion is closer to the first lens portion of the first surface than the locating portion.

4. The lens as defined in claim 1, wherein the first reference portion and the locating portion are arranged sequentially in a direction from the first lens portion of the first surface to the flange.

5. The lens as defined in claim 1, wherein the first reference portion and the locating portion have an included angle in between, and the included angle is an obtuse angle.

6. The lens as defined in claim 1, wherein the locating portion has an inclined plane.

7. A method of producing the lens defined in claim 1, comprising the steps of:
A. preparing a first mold and a second mold, wherein the first mold has a first cavity, and the second mold has a second cavity, which is precisely aligned with the first cavity;
B. placing an unsolidified glass material onto the first mold, wherein the glass material is between the first cavity and the second cavity;
C. moving one of or both the first mold and the second mold to make them closer to each other without being mutually contacted, wherein the glass material is pressed by a wall of the second cavity, and therefore a part of the glass material flows out of a portion between the first cavity and the second cavity, and the portion is inside a spacing between the first mold and the second mold;
D. solidifying the glass material, wherein the first surface is formed at where the glass material contacts a wall of the first cavity, the second surface is formed at where the glass material contacts the wall of the second cavity, and the flange is formed of the part of the glass material which is in the spacing between the first mold and the second mold;
E. moving away one of or both the first mold and the second mold to retrieve the lens.
